(19) United States
(12) Patent Application Publication
(10) Pub. No.: US 2008/0197998 A1
(43) Pub. Date: Aug. 21, 2008

(54) Safety Device and Method For Emitting a Directional Acoustic Alarm Signal

(76) Inventor: Theodorus Bernardus Jozef Campmans, Nieuwegein (NL)

Correspondence Address: Young & Thompson, 745 S. 23rd Street., Second Floor, Arlington, VA, 22202, US

(21) Appl. No.: 11/997,808

(22) PCT Filed: Aug. 4, 2006
(86) PCT No.: PCT/NL2006/000413

§ 371 Date: Feb. 4, 2008

(30) Foreign Application Priority Data
Aug. 4, 2005 (NL) 1029681

(51) Int. Cl. B60Q 1/26; G08B 3/00

(52) U.S. Cl. 340/463; 340/384.1

(57) ABSTRACT

The present invention relates to a safety device for emitting a substantially tonal acoustic alarm signal, the device comprising:—a sound source for generating an acoustic alarm signal,—directing means for directing the alarm signal in substantially one or more preferred directions and attenuating the alarm signal in the other directions. The invention also relates to a method for emitting a substantially tonal acoustic alarm signal, comprising of:—generating an acoustic alarm signal,—directing the alarm signal in substantially one or more preferred directions and attenuating the alarm signal in the other directions.

The present invention relates to a safety device and method for emitting a directional acoustic warning signal. The invention also relates to a vehicle provided with such a safety device.

In potentially dangerous situations it is usual, and often also required, that plant and equipment sound an alarm signal beforehand so that bystanders are warned about an occurring danger. When the equipment is for instance a vehicle such as a truck, power shovel, crane and the like, which can reverse without the driver having a full view behind this vehicle, an acoustic alarm signal is often emitted automatically so as to warn people standing behind the vehicle of the imminent danger. Such an alarm signal is also sounded when the plant or equipment is for instance a machine with moving parts, for instance a long conveyor belt, and the machine can be set into motion remotely (for instance from a control room) by an operator without the operator being able to oversee the area covered by the machine. Alarm signals are further sounded at railway crossings, wherein the alarm signal is emitted by an alarm bell sounding on all sides. Police cars, fire engines and ambulances, among others, can also sound alarm signals.

In the case of possible danger a warning signal will sound for a certain period in such cases, so that people who are possibly present know that the plant or equipment is about to be set into motion.

Standards may be laid down for the intensity and nature of the sound of these signals, for instance in accordance with NEN-EN 457 “Safety of machines. Auditory danger signals. General requirements, designs and tests.” The frequencies of common alarm signals generally lie between about 500 and 3500 Hz. The alarm signals often consist of a single frequency which switches on and off at certain time intervals, or a combination of a plurality of frequencies which are sounded intermittently.

It is usual for this purpose for alarm units or safety devices which can produce the warning sound to be placed on or close to the equipment or vehicles in question.

A drawback of the known safety devices is that the sound is also heard in the vicinity, where other people—who do not need to be warned—can be inconvenienced thereby.

Such a safety device is known from international application WO 2004/052075. In a determined embodiment the known device comprises a loudspeaker provided with two chambers, wherein the sound in the chambers is in counterphase. The chambers are connected to channels of different length. The sound entering the channels is in counterphase but, with a correct choice of channel lengths, the sound leaving the channels is in phase and is therefore amplified. The sound is however not directed such that the alarm signal is amplified in specific preferred directions and attenuated in the other directions, so that the alarm signal can be heard in the entire vicinity of the device.

The invention has for its object to provide a method and safety device in which the above stated drawback is obviated, or at least limited.

The invention also has for its object to limit the nuisance occurring for the surrounding area without the alarm signal losing its warning effect.

According to a first aspect of the present invention, there is provided for this purpose a safety device for emitting a substantially tonal acoustic alarm signal, the device comprising:

a sound source for generating the substantially tonal acoustic alarm signal,

directing means for directing the alarm signal in substantially one or more preferred directions and attenuating the alarm signal in the other directions, wherein the directing means comprise a splitting element which can be connected to the sound source for splitting the alarm signal into at least a first acoustic alarm signal and a second acoustic alarm signal, and wherein the splitting element is embodied for the purpose of providing a phase difference between the two alarm signals such that the substantially one or more preferred directions can be provided as a result of interference.

According to a further preferred embodiment, the splitting element is constructed from an input channel which splits into two or more output channels for splitting the alarm signal from the sound source into two, wherein the outlets of the output channels are situated at a fixed distance in order to provide a fixed phase difference between the alarm signals. In order to direct the sound even better, in a further preferred embodiment the device comprises a splitting element with which the acoustic alarm signal can be split into four or more alarm signals and wherein the splitting element is embodied for the purpose of providing a phase difference between the four or more different alarm signals such that the substantially one or more preferred directions can be provided as a result of interference.

According to a further preferred embodiment, the lengths of the output channels of the splitting element are substantially equal, so that the sound leaves the outlets substantially in phase.

In a preferred embodiment said distance between the outlets is set per pair of output channels to a predetermined value depending on the wavelength and the desired preferred direction(s) of the alarm signal. Through correct setting of this distance the alarm signal can be amplified in the desired preferred direction(s) and attenuated in the other directions in order to reduce the nuisance for the surrounding area. When in a further preferred embodiment said distance between the outlets per pair of channels is for instance substantially equal to half the wavelength of the alarm signal emitted by the sound source, a sound signal with a fixed, predetermined directional characteristic is obtained, in which the sound is amplified in a limited number of preferred directions and attenuated in the other directions.

According to a further preferred embodiment, the splitting element takes a symmetrical form.

According to a further preferred embodiment, the intermediate distance between the outlets of the output channels takes an adjustable form for the purpose of adjusting said preferred directions.

According to a further preferred embodiment, the channels of the splitting element take an at least partly curved form, for instance with one or more bends, so that a compact construction of the device can be provided.

According to a further preferred embodiment, the outer ends of the output channels are trumpet-shaped so as to be able to radiate as much sound energy as possible and to avoid reflections which could decrease the desired reduction resulting from interference.

According to a further preferred embodiment, the sound source comprises a first sound source and a second sound source, wherein the directing means comprise a control unit which is connected to the sound sources and with which the phase of the first acoustic alarm signal emitted by the first sound source and the second acoustic alarm signal emitted by the second sound source can be adjusted for the purpose of providing the substantially one or more preferred directions of the alarm signal as a result of interference.

According to a further preferred embodiment, the first sound source is disposed at a distance from the second sound source, and said distance is substantially equal to half the wavelength of the alarm signal emitted by the sound sources.

According to a further preferred embodiment, the phase of the first alarm signal is the same as the phase of the second alarm signal, and the preferred directions extend substantially perpendicularly of the connecting axis between the sound sources.

According to a further preferred embodiment, the device comprises a reflecting directional plate disposed close to the sound source or the outlets for the purpose of additional directing of the acoustic alarm signal.

According to a further preferred embodiment, the device comprises a first directional plate extending some distance from and substantially parallel to a plane through the sound sources or the outlets.

According to a further preferred embodiment, the device comprises a second directional plate extending substantially in a plane through the sound sources or the outlets. It is otherwise also possible to envisage fixing only the second directional plate (i.e. without the first directional plate) to the device.

According to a further preferred embodiment, a directional plate is chamfered in the part of its peripheral edge directed at the sound source so as to enable radiation of as much sound energy as possible and to avoid reflections which could decrease the desired reduction resulting from interference.

According to a further preferred embodiment, a third directional plate is arranged between the first and second directional plates for the purpose of emitting the alarm signal in—substantially—one preferred direction.

According to a further preferred embodiment, the third directional plate has a curved shape, for instance a (roughly) parabolic or elliptical shape or a hybrid thereof.

According to a further preferred embodiment, the device comprises a temperature sensor for determining the ambient temperature, wherein the control unit is coupled to the temperature sensor and adapted to adjust the frequency of the sound source or both sound sources subject to the detected temperature.

According to a further preferred embodiment, a sound source comprises one or more electric loudspeakers or other sound sources.

According to a further preferred embodiment, the acoustic alarm signal is a tonal sound signal. A tonal sound signal is here understood to mean a signal of one or more separate frequencies, or at least a signal of one or more separate narrow frequency bands.

According to a second aspect of the present invention, there is provided a vehicle such as a truck, power shovel or crane which is provided with the safety device described herein, wherein the directing means are embodied for the purpose of amplifying the alarm signal in one or more predetermined preferred directions relative to the vehicle and for attenuating said signal in the other directions. The vehicle preferably comprises means for switching on a safety device before the vehicle begins to reverse, wherein the safety device is disposed such that the preferred direction of the alarm signal is to the rear (optionally with an upward or downward component). A clearly localized area can be covered when the directing means are for instance placed high up on the rear of the vehicle and the alarm signal is directed obliquely or straight downward.

According to a third aspect of the present invention, a method is provided for emitting an alarm signal, comprising of:

generating a first tonal acoustic alarm signal,

generating a second tonal acoustic alarm signal,

directing the alarm signal in substantially one or more preferred directions and attenuating the alarm signal in the other directions, wherein the directing comprises of emitting the alarm signals with a phase difference such that substantially one or more preferred directions are provided as a result of interference.

The method preferably also comprises of emitting a first alarm signal and a second alarm signal with a phase difference between the first and second alarm signal such that the substantially one or more preferred directions are provided as a result of interference.

Further advantages, features and details of the present invention will become apparent from the following description of several preferred embodiments thereof. Reference is made in the description to the figures, in which:

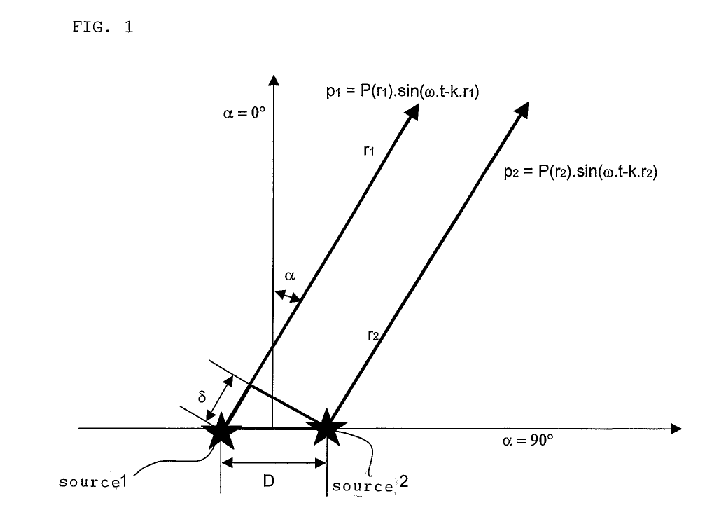

FIG. 1 shows a schematic view of two adjacently disposed sound sources;

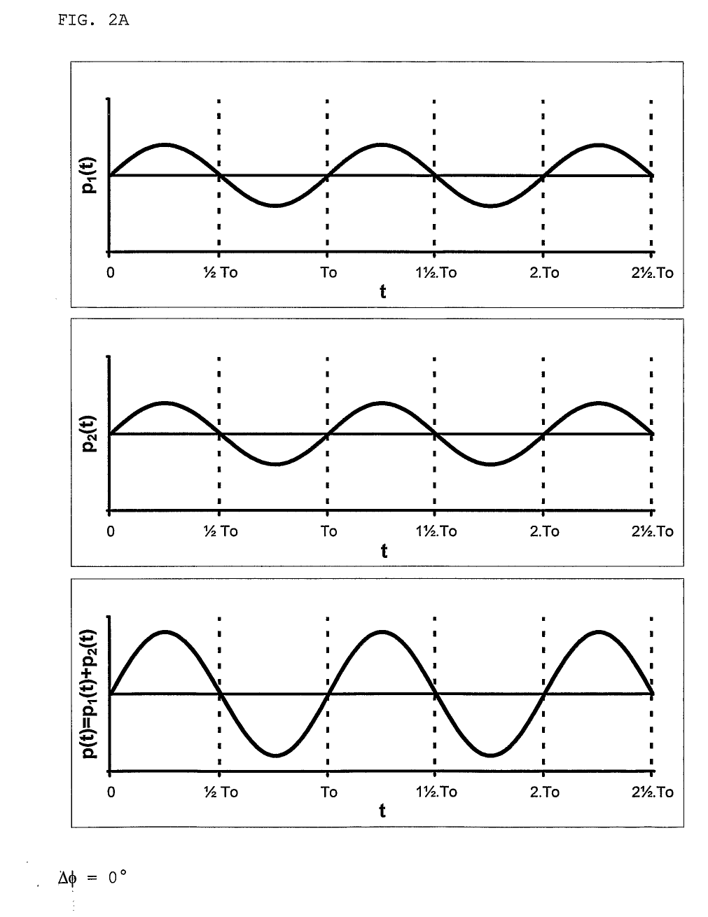

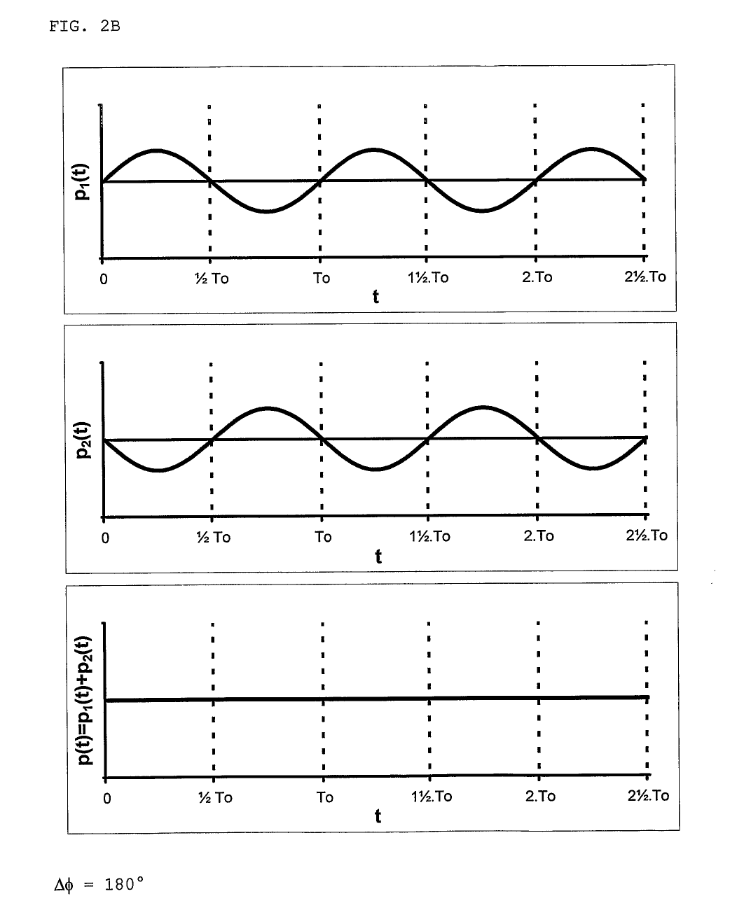

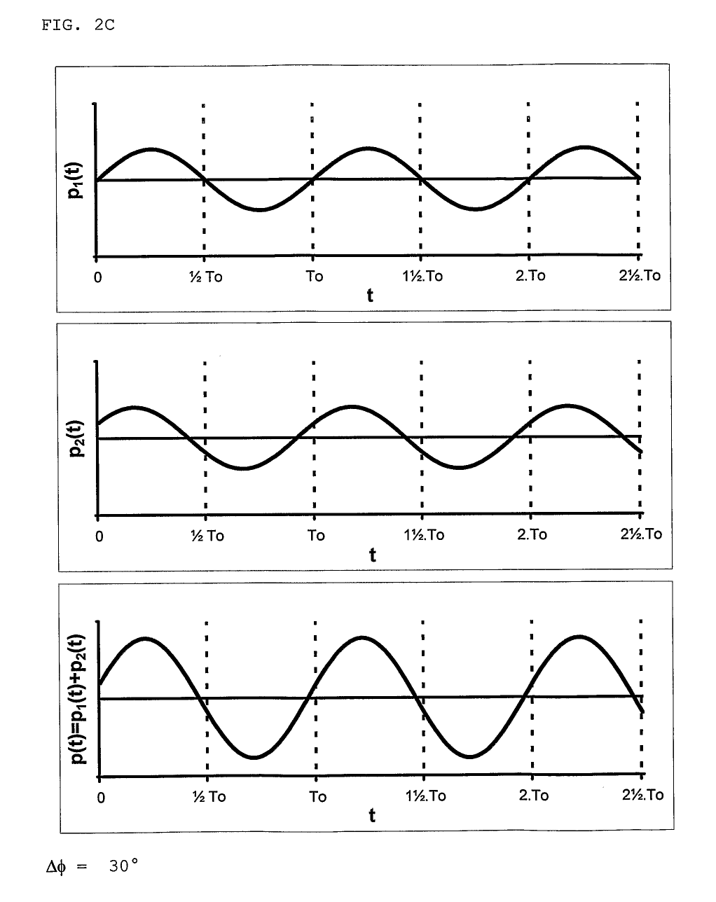

FIGS. 2A-2D show graphic representations of the addition of the sound of two tones of the same frequency and intensity, but with differing phase differences;

FIGS. 3A-3C show directional characteristics of two sound sources placed at a mutual distance D;

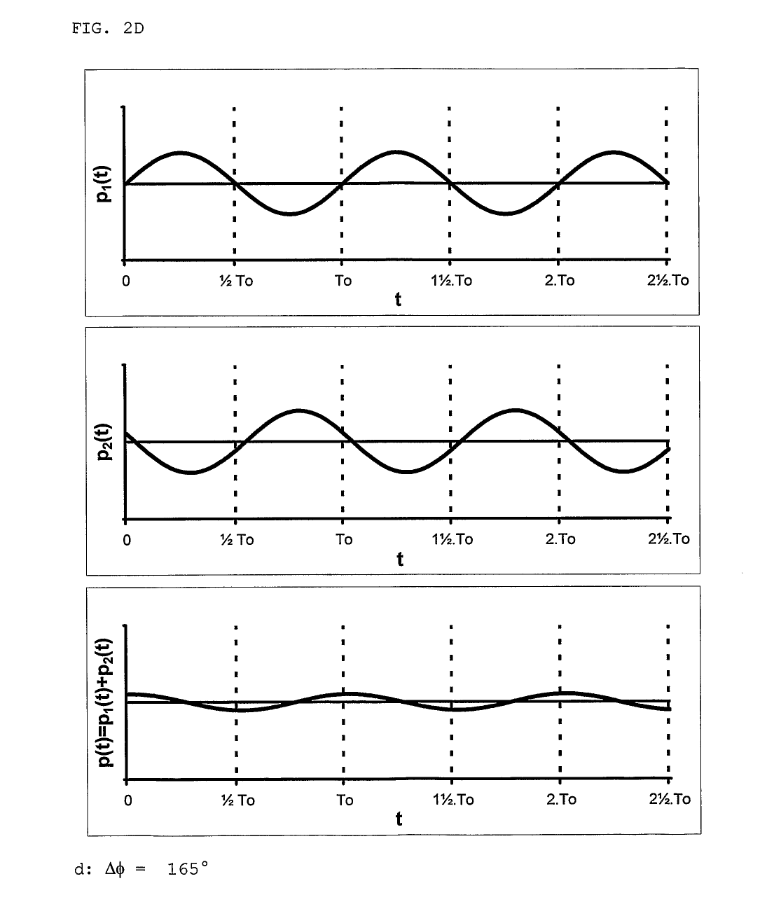

FIGS. 4A and 4B show respectively a top view and a side view of a first preferred embodiment of the invention;

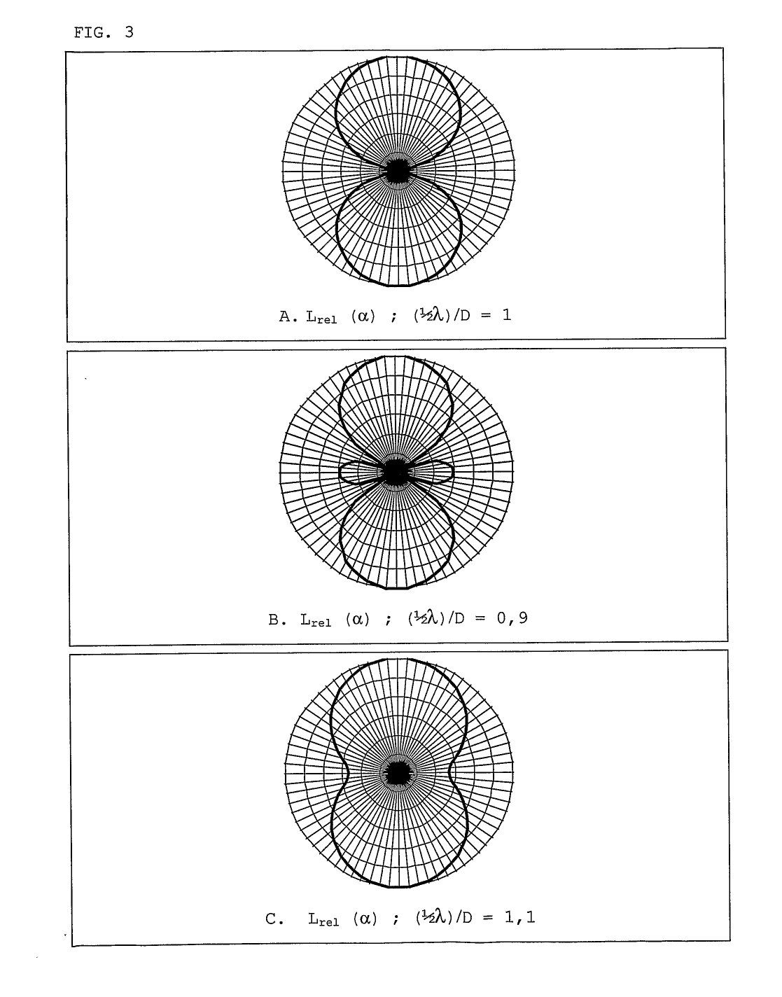

FIGS. 5A and 5B show respectively a top view and a side view of a second preferred embodiment of the invention;

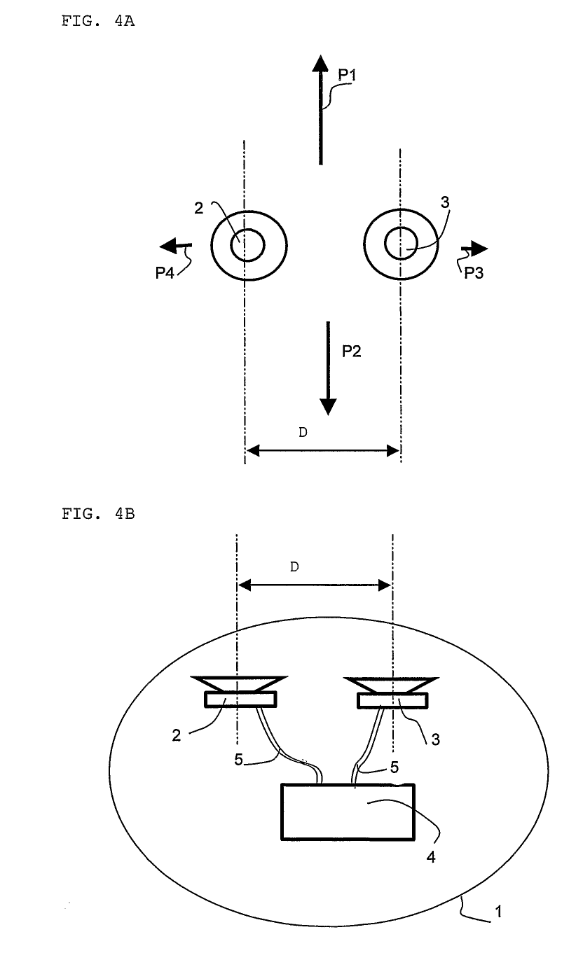

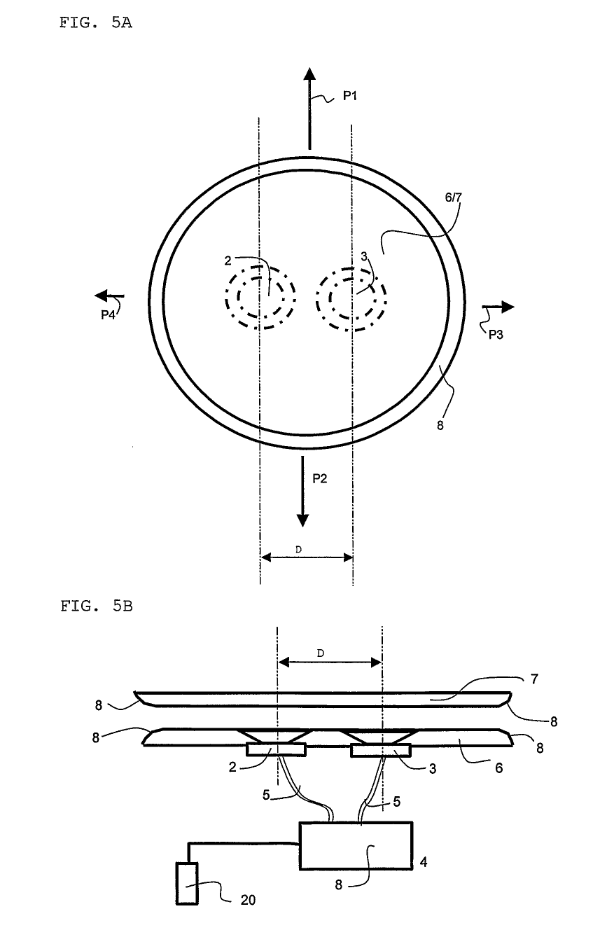

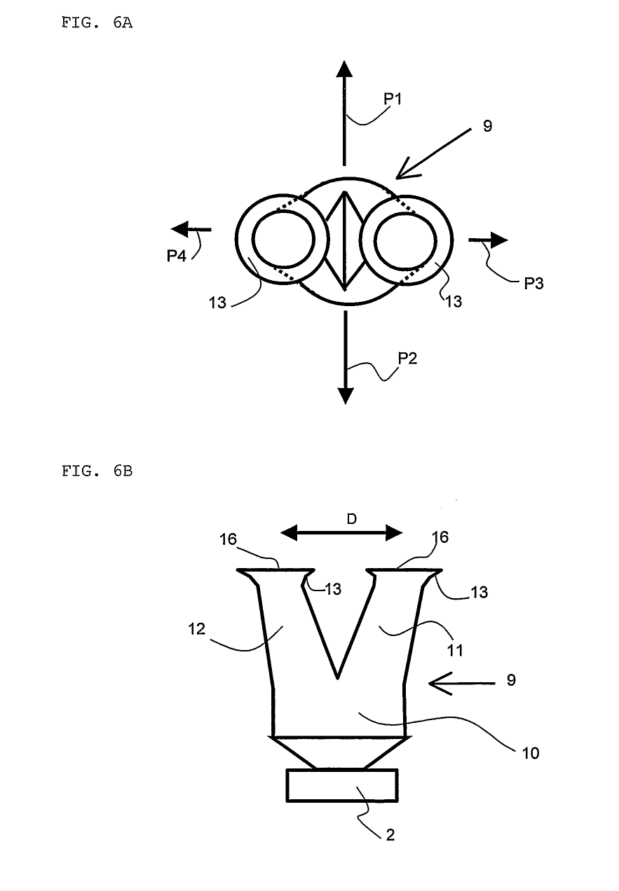

FIGS. 6A and 6B show respectively a top view and a side view of a third preferred embodiment of the invention;

FIGS. 7A and 7B show respectively a top view and a side view of a fourth preferred embodiment of the invention;

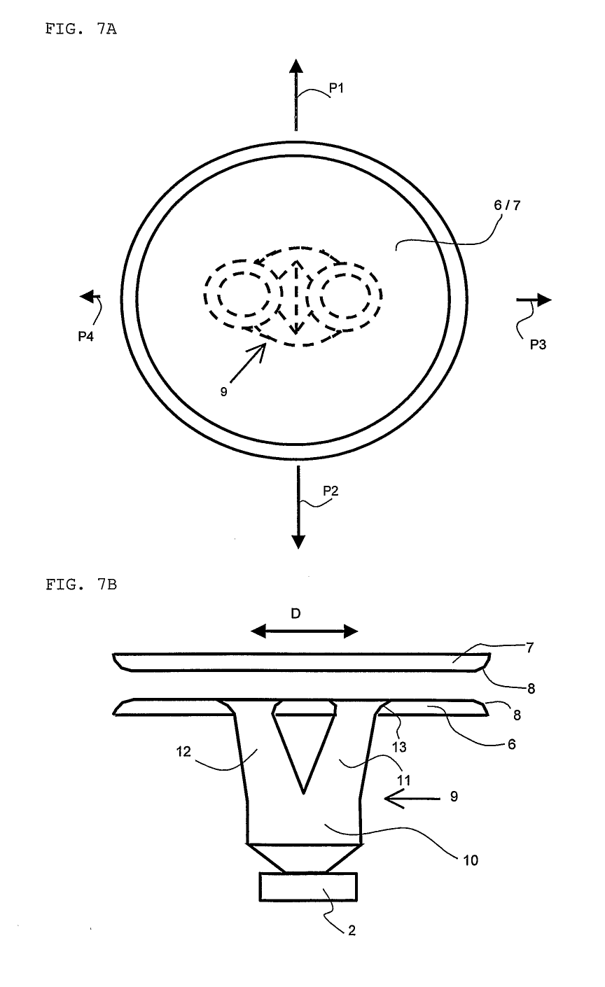

FIGS. 8A and 8B show respectively a top view and a side view of a fifth preferred embodiment of the invention;

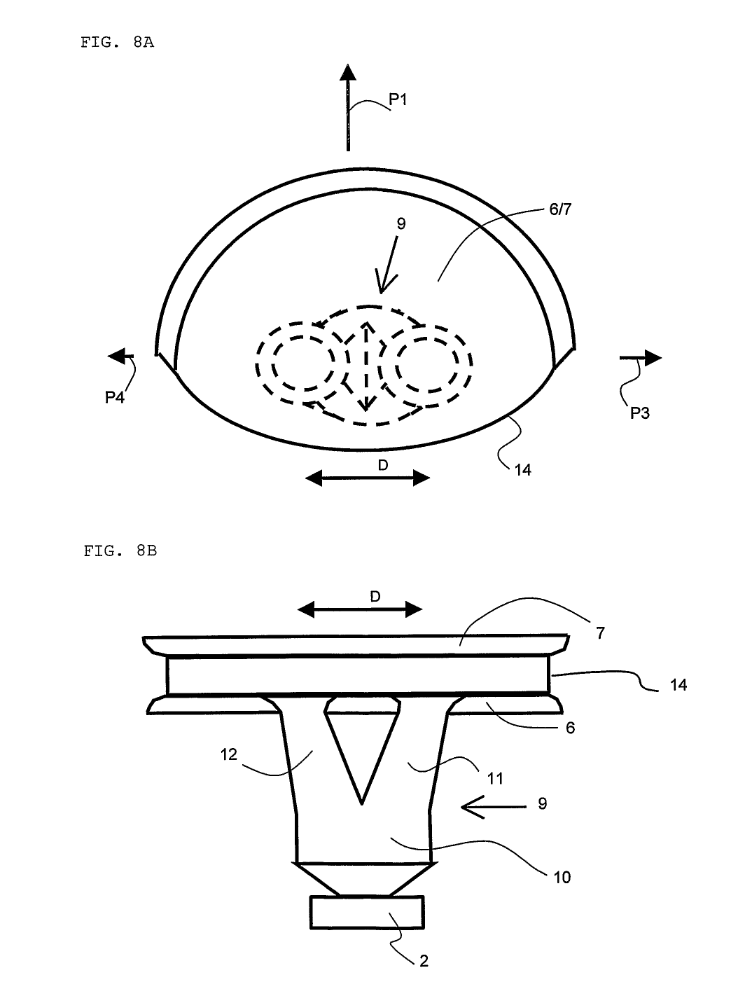

FIGS. 9A and 9B show respectively a top view and a side view of a sixth preferred embodiment of the invention; and

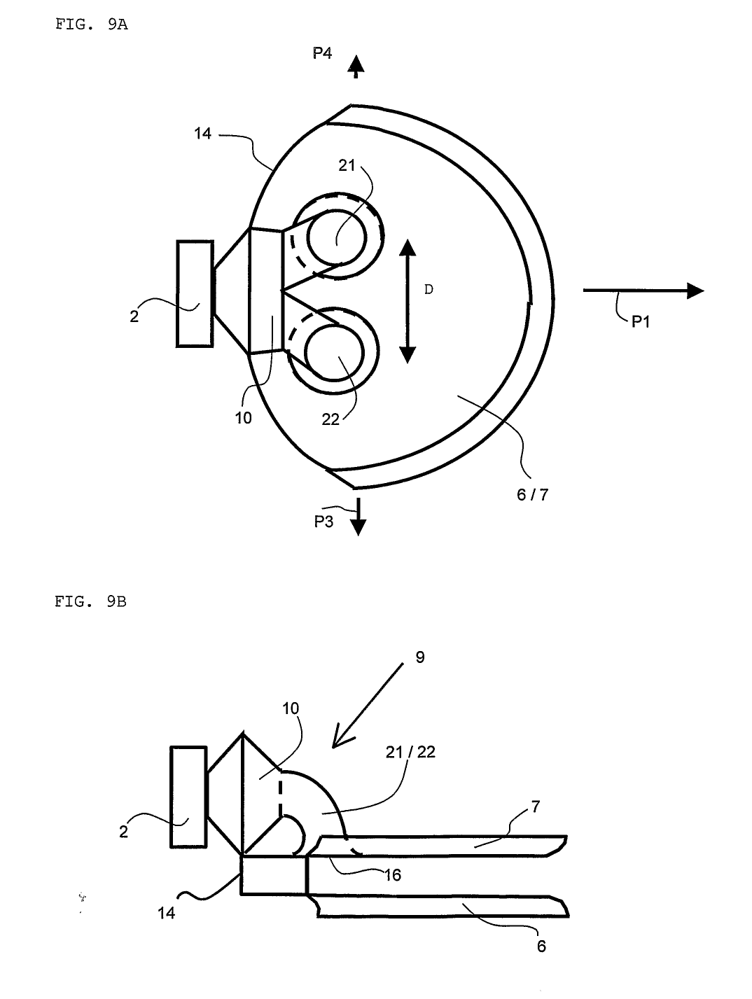

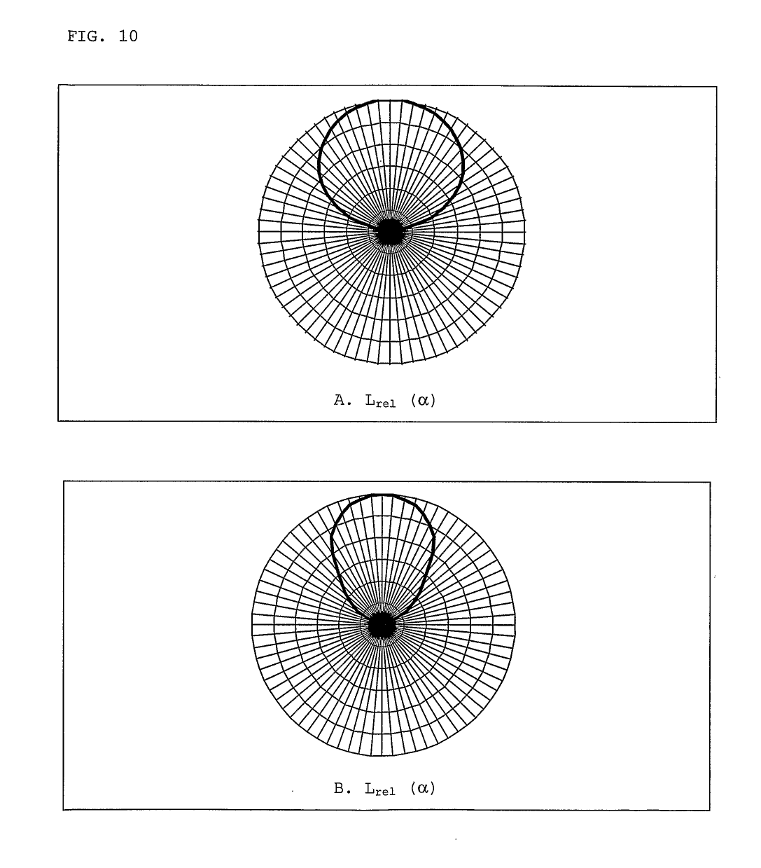

FIGS. 10A and 10B show respectively a view of the directional characteristic during use of respectively an elliptical and parabolic reflection plate.

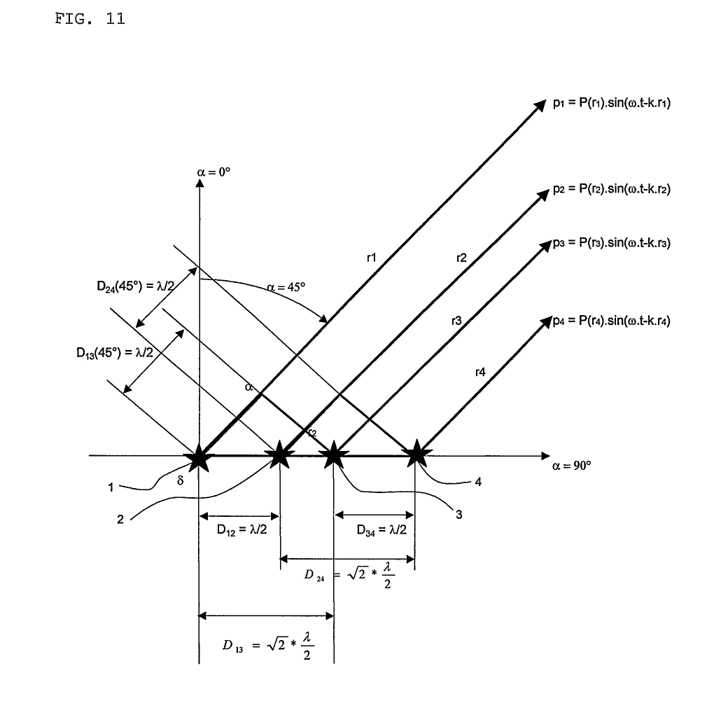

FIG. 11 shows a schematic view of two pairs of sound sources lying in line;

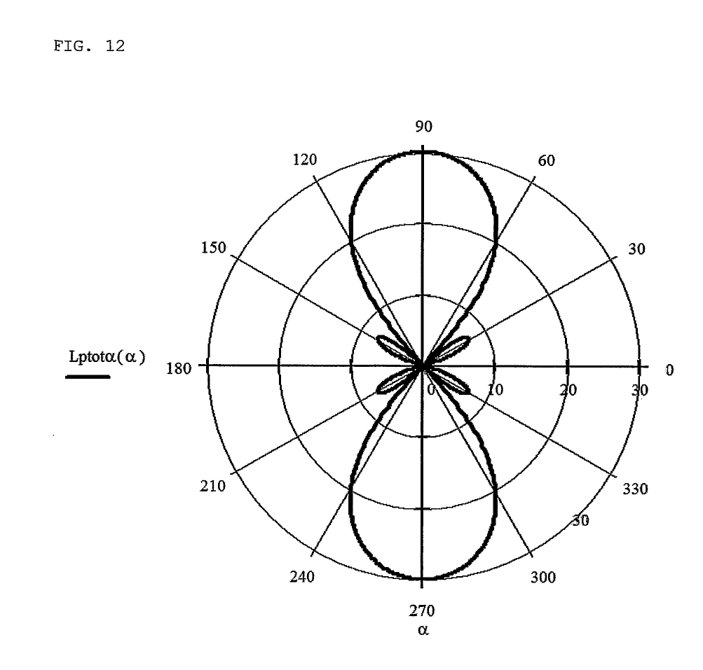

FIG. 12 shows the directional characteristic of two sources at a half-wavelength (A) and a further two sound sources at, with all four sources equally in phase;

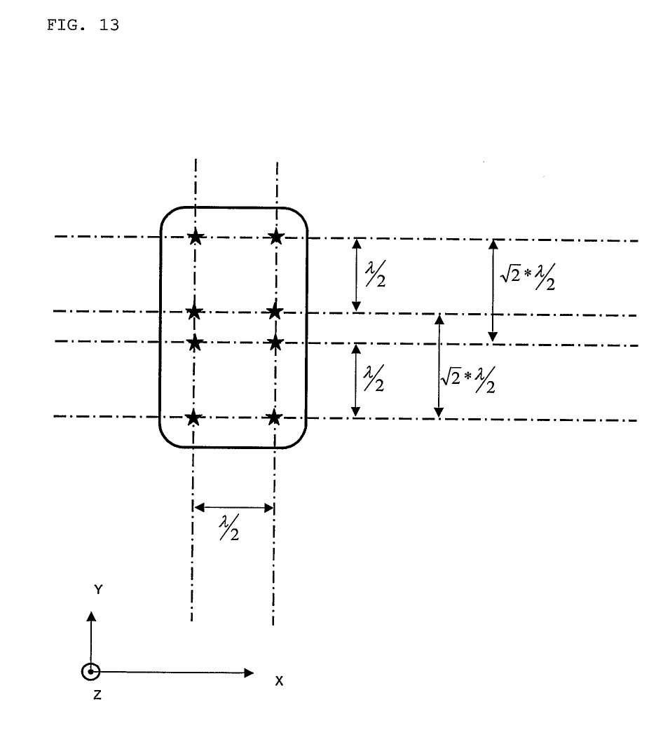

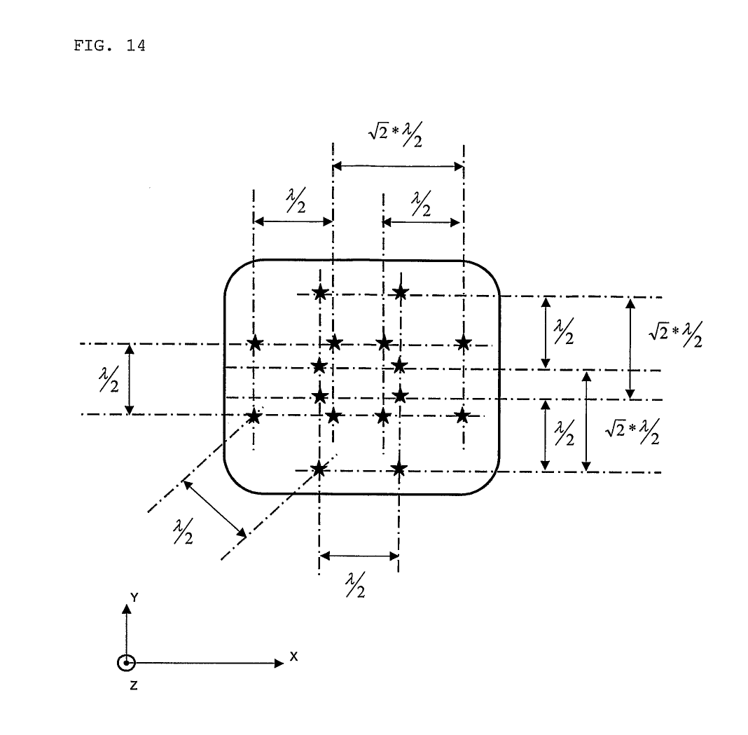

FIGS. 13 and 14 show two possible arrangements with various pairs of openings in order to bring about the directional effect of the tonal sound;

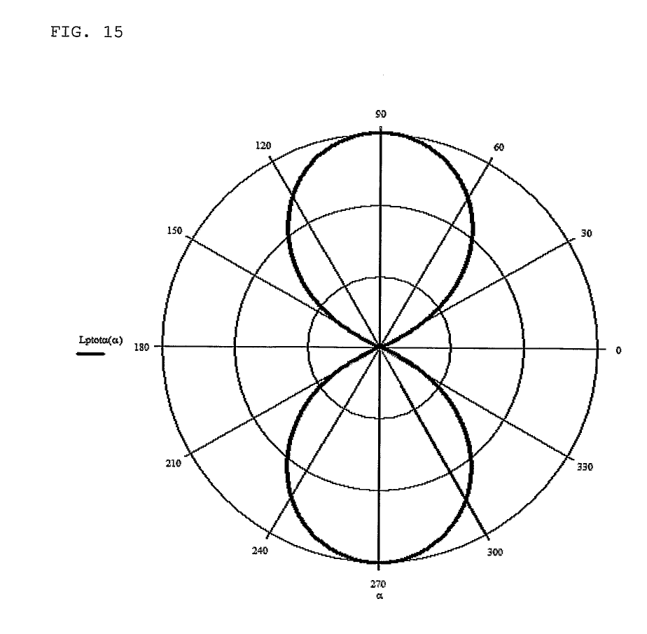

FIG. 15 shows the directional characteristic associated with the source configuration according to FIG. 14;

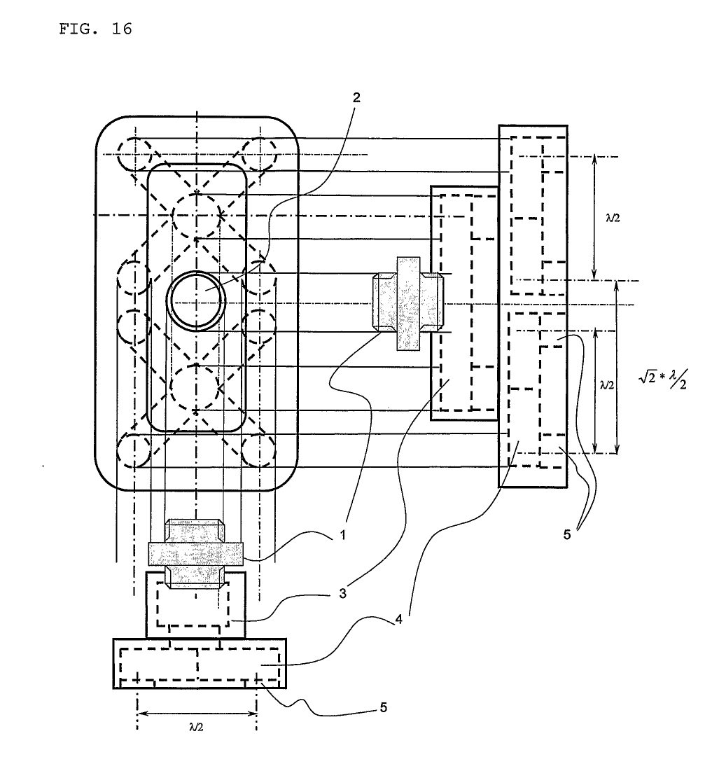

FIG. 16 shows a top view and two side views of a seventh preferred embodiment of the invention.

FIG. 1 shows a schematic representation of two sound sources close to each other, at a distance D, with the sound beams drawn at an angle α. The following expressions apply to the outline situation if the distance between the two sources is much greater than the difference in path length δ.

p₁(r₁)=P(r₁)·sin(ω·t−k·rₗ) (1)

with: p₁(r₁)=sound pressure at distance r₁ from source 1 [Pa]
ω=angular frequency, angular velocity=2·n·f [rad/s]
t=time [s]
k=wave number (ω/c=2·π/λ) [1/m]

pₜₒₜ²=2·P²·(1+cos(Δφ)) (2)

with: Δφ=phase difference [rad]
P=pressure amplitude of sound wave from one source [Pa]
Pₜₒₜ=pressure amplitude of total sound wave [Pa]
   For the phase difference there applies:

Δφ=(2·π—f/c)·D·sin(α) (3)

with: f=frequency of the sound [Hz]
D=mutual distance of the two sources [m]
c=sound velocity [m/s]
α=angle of radiation (see FIG. 1) [rad]
   In air there applies approximately:

c=20,1·T^{1/2} [m/s] (4)

with: T =absolute temperature [K]

δ=D·sin(α) (5)

with:

δ=difference in path length between r₁ en r₂ for a point located far from both sources.

FIGS. 2A-2D each show a number of graphs in which the sound pressure p is plotted against time, depending on the phase difference. The figures show a clear graphic representation of the addition of the sound of two tones of the same frequency and intensity, but with differing phase differences. The graph of FIG. 2A shows how the sound adds up when there is no phase difference. The graph of FIG. 2B shows how the sound extinguishes at a phase difference of 180°. The graph of FIG. 2C shows how the sound is added up when there is a small phase difference. The graph of FIG. 2D shows how the sound is reduced by extinguishing when the phase difference is almost 180° (165° is chosen here at random).

FIGS. 3A-3C show the directional characteristics for the situation shown in FIG. 1, in which the distance D between sources is equal to half the wavelength, when the distance is slightly smaller than half the wavelength, and when this distance D is slightly greater than half the wavelength. Plotted is the quantity:

Lᵣₑₗ=10.·og(Pₜₒₜ²/(4·P²)) (5)

FIGS. 4A and 4B show a first preferred embodiment of safety device 1, in which loudspeakers 2 and 3 are placed at a mutual distance D of about half a wavelength of the tonal alarm signal. Loudspeakers 2 and 3 are connected via electrical cables 5 to a control unit or operating unit 4, for instance a computer or an electronic switch unit, which provides the loudspeakers with a coherent electrical signal. Loudspeakers 2 and 3 convert the electrical signal from operating unit 4 into an acoustic alarm signal. As is apparent from the directional characteristics of FIGS. 3A-3C, and as is clearly shown in FIGS. 4A and 4B, the alarm signal is directed upward (direction P₁) and downward (direction P₂), and the alarm signal has the highest sound level in these directions. In lateral directions (direction P₃ and P₄) the sound is reduced the most (at least in the situation where distance D is equal to half the wavelength).

FIGS. 5A and 5B show a second embodiment with loudspeakers 2 and 3 placed at a distance D from each other, wherein operating unit 4 must give the signal. The two round (or otherwise shaped) directional plates 6 and 7 limit the sound in upward and downward direction and hereby direct the sound in a plane (in the shown embodiment a horizontal plane, but this can be any random plane, for instance vertical or oblique). These directional plates 6 and 7 are preferably rounded slightly on their peripheral edges 8 on the mutually facing sides, while directional plates 6,7 take a flat form in the central area, i.e. in the vicinity of the loudspeakers. The rounding on the edge has for its object to achieve the least possible influence by these edges due to for instance reflection of the sound. The connecting elements necessary to hold fast the top plate are omitted in the drawing for the sake of clarity. The connecting elements must preferably be as small as possible so as to disturb the sound field as little as possible.

FIGS. 6A and 6B show a third preferred embodiment of safety device 1, wherein the required sound signal is obtained using a single sound source 2. This is possible by applying a splitting element 9 which consists of, among other things, an input channel 10 and two output channels 11 and 12. Splitting element 9 splits the “sound flow” from sound source 2 in symmetrical manner into two separate sound flows. The split channels 11 and 12 continue such that they debouch at the desired mutual distance D from each other. The shape of the outer ends 13 of each output channel is preferably rounded so as to allow through as much sound energy as possible.

FIGS. 7A and 7B show a fourth preferred embodiment of the invention having, compared to the above discussed third embodiment, the same addition of directional plates 6 and 7 as in the second preferred embodiment.

FIGS. 8A and 8B show a fifth preferred embodiment having, compared to the fourth preferred embodiment, a reflection plate 14 which shields the sound in one direction and, by reflecting this sound, radiates the sound more intensely in the other direction. The shape of this directional plate can for instance be elliptical or parabolic. A parabolic reflection plate can for instance ensure that the reflected sound from device 1 is directed as a practically parallel sound beam. Numerous other shapes are also possible for influencing as desired the directional characteristics of device 1. Two examples of directional characteristics which can result from the use of different shapes of the directional plates are shown in FIGS. 10A and 10B. FIG. 10A shows the theoretical directional characteristic when an elliptical reflection plate is applied, while FIG. 10B shows an approximated theoretical directional characteristic when a parabolic reflection plate is applied.

FIGS. 9A and 9B show a sixth embodiment. This embodiment corresponds with the above discussed fifth embodiment, wherein the substantially straight channels 11,12 of the splitting element are however replaced by curved channels 21,22. (Almost) the same effect can hereby be achieved, although with a potentially more compact structure of device 1.

The operation of the safety device is as follows. The sound from two sound sources, each emitting sound with the same frequency and the same intensity and in equal phase, is reduced to a certain extent in the directional axis from the one loudspeaker to the other loudspeaker. This is because of the difference in distance: the sound from the one source to the reception point takes slightly longer than the sound from the other source to the same reception point. If this difference in distance is equal to half the wavelength, a complete extinguishing occurs. This is shown graphically in FIGS. 2A-2D, where the addition of two tones with a number of phase differences is demonstrated. As is apparent from the figures, the maximum damping occurs in that direction in which the difference in path length is equal to ½ (wherein it is noted that a difference of 1½λ, 2½λ and so on is in principle also possible).

The directional effect can be made stronger than that which can be obtained with two sources by operating with multiple pairs of sources of equal phase. Each pair has the mutual distance of substantially half a wavelength. The distance between the pairs determines an extra direction in which the sound extinguishes. This is shown in FIG. 11, where the distance between the two shown pairs amounts to ½\sqrt{2}·λ. At 45° the sound from source 1 is hereby extinguished by source 3, and the sound from source 2 by source 4. At 90° the sound from source 1 is extinguished by source 2 and the sound from source 3 by source 4. This results in a directional characteristic as according to FIG. 12. This can also be extended into the other dimension by also placing sources adjacently of each other. Two possible configurations for this purpose are shown in FIGS. 13 and 14. A possible splitting element for obtaining the pattern of FIG. 13 according to a seventh preferred embodiment is shown in FIG. 16. A sound source 1 is herein connected to opening 2 on the splitting element. In the first part 3 the signal is split into two equal parts. In the second part 4 each split part is then split into four equal parts so that the sound can exit to the outside via outlets 5 in the desired pattern with the desired mutual distances.

The device is sensitive to a greater or lesser extent to small fluctuations, for instance due to the variation in the sound velocity caused by variations in the temperature. At a certain frequency the wavelength hereby increases when the temperature increases. The dependence on the temperature is demonstrated above in formula 4. If the difference in path length to the sound sources approaches ½λ, a good sound reduction relative to α=0° already occurs. This is shown in FIGS. 3A-3C.

In some embodiments it may be necessary to compensate for the above stated temperature influences. This is for instance possible by adapting the exact frequency to be emitted to the temperature, or by making distance D variable. Distance D could for instance be affected under the influence of the temperature by making use of materials with a suitably chosen thermal coefficient of expansion, or by means of a bimetal. Embodiments can also be envisaged in which operating unit 4 is coupled to a temperature gauge (for instance temperature gauge 20 in FIG. 5B), in which said distance between the sound sources and/or the frequency of the emitted sound is adjusted under control of operating unit 4 subject to the temperature measured by sensor 20.

Good use can be made of the above stated phenomena in the design of the device. When a sound source which gives a signal consisting of multiple tones must for instance be directed, an optimal compromise can then be sought on the basis of the occurring directional characteristics.

The sound directing means can be formed in a number of ways.

A first method for making the sound directing means is a construction with only one loudspeaker. The two or more identical sound sources necessary for the principle of the directing means are created by splitting the channel, preferably in symmetrical manner, by means of a splitting element 9 as discussed above. The channel lengths of the different paths from the sound source to the outlets must preferably have an equal length. Outlets 16 of the embodiment with two individual channels must debouch at the desired distance D. In the embodiment with more than two channels, these channels must debouch in the desired pattern.

The sound directing means can also radiate the sound strongly in one direction if use is made of reflection plate 14 in FIGS. 8A and 8B or reflection plate 14 in FIGS. 9A and 9B. FIGS. 9A and 9B also show clearly that the splitting channel can also be embodied with a bend so as to thus optionally obtain a more compact structure.

A second method is with two loudspeakers or other sound sources which are provided, for instance electronically, with a sound signal of the same strength and frequency. If the phase difference between the two signals is 0°, the behaviour will then be as stated. In this electronic variant it is possible to add an additional phase difference in electronic manner. If this addition increases continuously, the directional characteristic will then start to “rotate”. This is for instance possible in the first and second preferred variants. It is also possible to give the sound directing means a constant extra phase difference electronically. The direction with the strongest sound emission can hereby be set. A significant advantage is that this influencing can take place without mechanical parts having to move.

This directional effect in one direction can otherwise also be created by combining a splitting element with two or more loudspeakers as addition to the second preferred embodiment. Two sound sources could thus also be placed in one sound directing means, these sources each being split into two or more channels so as to thus obtain an optimal directional characteristic for both frequencies.

The present invention is not limited to the above described preferred embodiments thereof; the rights sought are defined by the following claims, within the scope of which many modifications can be envisaged.

1. Safety device for emitting a substantially tonal
acoustic alarm signal, the device comprising:
a sound source for generating the substantially tonal acoustic alarm signal,
directing means for directing the alarm signal in substantially one or more preferred directions and attenuating the alarm signal in the other directions, wherein the directing means comprise a splitting element which can be connected to the sound source for splitting the alarm signal into at least a first acoustic alarm signal and a second acoustic alarm signal, and wherein the splitting element is embodied for the purpose of providing a phase difference between the two alarm signals such that the substantially one or more preferred directions can be provided as a result of interference.

2. Safety device as claimed in claim 1, wherein the splitting element is constructed from an input channel which splits into two or more output channels for splitting the alarm signal from the sound source, wherein the outlets of the output channels are situated at fixed distances and in a fixed pattern in order to provide a fixed phase difference between the two alarm signals.

3. Safety device as claimed in claim 1 wherein the directing means comprise a splitting element connectable to the sound source for splitting the alarm signal into four or more acoustic alarm signals, and wherein the splitting element is embodied for the purpose of providing a phase difference between the four or more different alarm signals such that the substantially one or more preferred directions can be provided as a result of interference.

4. Safety device as claimed in claim 3, wherein said distance is set per pair of output channels to a predetermined value depending on the wavelength and the desired preferred direction(s) of the alarm signal.

5. Safety device as claimed in claim 2, wherein said distance per pair of output channels is substantially equal to half the wavelength of the alarm signal emitted by the sound source.

6. Safety device as claimed in claim 1, wherein the lengths of the output channels of the splitting element are substantially equal.

7. Safety device as claimed in claim 1, wherein the splitting element takes a symmetrical form.

8. Safety device as claimed in claim 1, wherein the intermediate distance between the outlets of the output channels takes an adjustable form for the purpose of adjusting said preferred directions.

9. Safety device as claimed in claim 1, wherein the channels of the splitting element take an at least partly curved form.

10. Safety device as claimed in claim 1, wherein the outer ends of the output channels are trumpet-shaped.

11. Safety device as claimed in claim 1, comprising a reflecting directional plate disposed close to the outlets for the purpose of additional directing of the acoustic alarm signal.

12. Safety device as claimed in claim 11, comprising a first directional plate extending some distance from and substantially parallel to a plane through the outlets.

13. Safety device as claimed in claim 11, comprising a second directional plate extending substantially in a plane through the outlets.

14. Safety device as claimed in claim 12, wherein a directional plate is chamfered in the part of its peripheral edge directed at the sound source.

15. Safety device as claimed in claim 12, wherein a third directional plate is arranged between the first and second directional plates for the purpose of emitting the alarm signal in substantially one preferred direction.

16. Safety device as claimed in claim 15, whrein the third directional plate has a curved shape, for instance an almost parabolic or elliptical shape.

17. Vehicle such as a truck, power shovel or crane provided with at least one safety device as claimed in any of the foregoing claims, wherein the directing means are embodied for the purpose of amplifying the alarm signal in one or more predetermined preferred directions relative to the vehicle and for attenuating said signal in the other directions.

18. Vehicle as claimed in claim 17, comprising means for switching on the safety device when the vehicle reverses, and wherein the safety device is disposed such that the preferred direction of the alarm signal is to the rear.

19. Vehicle as claimed in claim 18, in particular a police car, fire engine or ambulance, comprising means for allowing the operator, usually the driver, to switch on a safety device, wherein the safety device is disposed such that the preferred direction of the alarm signal is to the front.

20. Safety device for emitting a substantially tonal acoustic alarm signal, the device comprising:
a first sound source for generating an acoustic alarm signal,
a second sound source for generating an acoustic alarm signal,
directing means for directing the alarm signal in substantially one or more preferred directions and attenuating the alarm signal in the other directions, wherein the directing means comprise a control unit which is connected to the sound sources and with which the phase of the first acoustic alarm signal emitted by the first sound source and the second acoustic alarm signal emitted by the second sound source can be adjusted for the purpose of providing the substantially one or more preferred directions of the alarm signal as a result of interference.

21. Safety device as claimed in claim 20, wherein the first sound source is disposed at a distance from the second sound source, and wherein said distance is substantially equal to half the wavelength of the alarm signal emitted by the sound sources.

22. Safety device as claimed in claim 21, wherein the phase of the first alarm signal is the same as the phase of the second alarm signal, and the preferred directions extend substantially perpendicularly of the connecting axis between the sound sources.

23. Safety device as claimed in claim 20, comprising a reflecting directional plate disposed close to the sound source or the outlets for the purpose of additional directing of the acoustic alarm signal.

24. Safety device as claimed in claim 23, comprising a first directional plate extending some distance from and substantially parallel to a plane through the sound sources or the outlets.

25. Safety device as claimed in claim 23, comprising a second directional plate extending substantially in a plane through the sound sources or the outlets.

26. Safety device as claimed in 23, wherein a directional plate is chamfered in the part of its peripheral edge directed at the sound source.

27. Safety device as claimed in claim 25, wherein a third directional plate is arranged between the first and second directional plates for the purpose of emitting the alarm signal in substantially one preferred direction.

28. Safety device as claimed in claim 27, wherein the third directional plate has a curved shape, for instance an almost parabolic or elliptical shape.

29. Safety device as claimed in claim 20, comprising a temperature sensor for determining the ambient temperature, wherein the control unit is coupled to the temperature sensor and adapted to adjust the frequency of at least one of the sound sources subject to the detected temperature.

30. Safety device as claimed in claim 20, wherein a sound source comprises one or more electric loudspeakers.

31. Vehicle such as a truck, power shovel or crane, provided with at least one safety device as claimed in claim 20.

32. Method for emitting a substantially tonal acoustic alarm signal, comprising of:
generating a first tonal acoustic alarm signal,
generating a second tonal acoustic alarm signal,
directing the alarm signal in substantially one or more preferred directions and attenuating the alarm signal in the other directions, wherein the directing comprises of emitting the alarm signals with a phase difference such that substantially one or more preferred directions are provided as a result of interference.

33. Method as claimed in claim 32, comprising of guiding the first and second alarm signal through output channels provided with outlets and setting the distance between the outlets at a predetermined value depending on the wavelength and the desired preferred direction(s) of the alarm signal.

34. Method as claimed in claim 32 further comprising applying a safety device comprising:
a sound source for generating the substantially tonal acoustic alarm signal,
directing means for directing the alarm signal in substantially one or more preferred directions and attenuating the alarm signal in the other directions, wherein the directing means comprise a splitting element which can be connected to the sound source for splitting the alarm signal into at least a first acoustic alarm signal and a second acoustic alarm signal, and wherein the splitting element is embodied for the purpose of providing a phase difference between the two alarm signals such that the substantially one or more preferred directions can be provided as a result of interference.
